(19) United States
(12) Patent Application Publication
(10) Pub. No.: US 2014/0133191 A1
(43) Pub. Date: May 15, 2014

(54) POWER CONVERTER AND CONTROL METHOD THEREOF

(71) Applicant: NEOENERGY MICROELECTRONIC, INC., Chupei City (TW)

(72) Inventors: Kuan-Sheng WANG, Taoyuan Hsien (TW); Ren-Huei TZENG, Taoyuan (TW)

(73) Assignee: NeoEnergy Microelectronic, Inc., Chupei City (TW)

(21) Appl. No.: 13/676,996

(22) Filed: Nov. 14, 2012

(51) Int. Cl. H02M 3/335

(52) U.S. Cl. CPC H02M 3/33523
USPC 363/21.08

(57) ABSTRACT

A power converter is provided. A transformer includes a primary winding for providing a primary voltage according to an input voltage, a secondary winding for providing a secondary voltage according to the primary voltage and an auxiliary winding for providing a reflection voltage according to the secondary voltage. A first switch coupled between the primary winding of the transformer and a ground has a control terminal for receiving a first control signal. A second switch coupled to the secondary winding has a control terminal for receiving a second control signal. A controller provides the first control signal to switch the first switch, so as to control the transformer to provide the secondary voltage. The controller provides the second control signal to switch the second switch according to the first control signal and the reflection voltage, so as to provide an output voltage in response to the secondary voltage.

### BACKGROUND OF THE INVENTION

1. Field of the Invention

The invention relates to a power converter, and more particularly to a synchronous rectifier (SR) power converter.

2. Description of the Related Art

In a typical power converter, a main switch is placed on a primary side of a transformer and connected in series with the primary winding of the transformer, and a rectifier circuit which is made up of rectifying diodes is placed on a secondary side of the transformer. The magnetizing inductance of the primary winding of the transformer is configured to receive the current from the voltage input terminal of the power converter and store energy therein, and transfer the stored energy to the secondary side of the transformer according to the on/off operations of the main switch. The rectifier circuit disposed at the secondary side of the transformer is used to rectify the AC voltage induced on the secondary side of the transformer into a rectified DC voltage. The rectified DC voltage is then smoothed to generate an output DC voltage for use by a load. Because diodes can cause considerable conduction loss during the switching operation, the rectifying diodes within the rectifier circuit have been replaced with transistors, so as to implement a synchronous rectifier in conventional power converters.

The power converter using a synchronous rectifier (SR) can reduce the power loss of the converter and improve the overall efficiency of the converter. Typically, a SR controller resides on the secondary side of the transformer. The SR controller senses a current flowed through the secondary side of the transformer and determines when to turn on or turn off the transistor. However, it is difficult to sense the current because of the variations caused by the transistor characteristics and an operation mode of the power converter, such as continuous current mode (CCM) or discontinuous current code (DCM). For example, in CCM mode, The SR controller generates a secondary driving signal according to the sensed current, so as to control the SR. However, the secondary driving signal will be easy to be overlapped with a primary driving signal (i.e. a dead time), thereby causing the transformer shorted and damaged. Furthermore, in DCM mode, the SR is better to improve efficiency. However, it will not be applied full time in the DCM condition for the SR, thereby the efficiency will be not optimized.

Therefore, a sophisticated driving circuit is desired to drive the synchronous rectifier switch of the synchronous rectifier.

### BRIEF SUMMARY OF THE INVENTION

Synchronous rectifier power converters are provided. An embodiment of a power converter is provided. The power converter comprises: a transformer, comprising a primary winding for providing a primary voltage according to an input voltage, a secondary winding for providing a secondary voltage according to the primary voltage and an auxiliary winding for providing a reflection voltage according to the secondary voltage; a first switch coupled between the primary winding of the transformer and a ground, having a control terminal for receiving a first control signal; a second switch coupled to the secondary winding, having a control terminal for receiving a second control signal; and a controller, providing the first control signal to switch the first switch, so as to control the transformer to provide the secondary voltage. The controller provides the second control signal to switch the second switch according to the first control signal and the reflection voltage, so as to provide an output voltage in response to the secondary voltage.

Furthermore, another embodiment of a power converter is provided. The power converter comprises: a transformer, comprising a primary winding for providing a primary voltage according to an input voltage and a secondary winding for providing a secondary voltage according to the primary voltage; a reference unit coupled to the transformer, providing a reference signal according to a reflection voltage corresponding to the secondary voltage; a first switch coupled between the primary winding of the transformer and a ground; a second switch coupled to the secondary winding; and a controller, switching the first switch, so as to control the transformer to provide the secondary voltage. The controller switches the second switch according to the reference voltage and a switching state of the first switch, so as to provide an output voltage in response to the secondary voltage.

Furthermore, an embodiment of a control method for a power converter is provided, wherein the power converter comprises a transformer, a first switch and a second switch. A first control signal is provided to switch the first switch coupled between a primary winding of the transformer and a ground, so as to control the transformer to provide a secondary voltage at a secondary winding of the transformer, wherein an auxiliary winding of the transformer provides a reflection voltage according to the secondary voltage. A second control signal is provided to switch the second switch coupled to the secondary winding according to the first control signal and the reflection voltage. The power converter provides an output voltage in response to the secondary voltage

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a synchronous rectifier (SR) power converter for converting an input voltage Vin into an output voltage Vout according to an embodiment of the invention; and

FIG. 2 shows an exemplary waveform illustrating the signals of the synchronous rectifier power converter of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

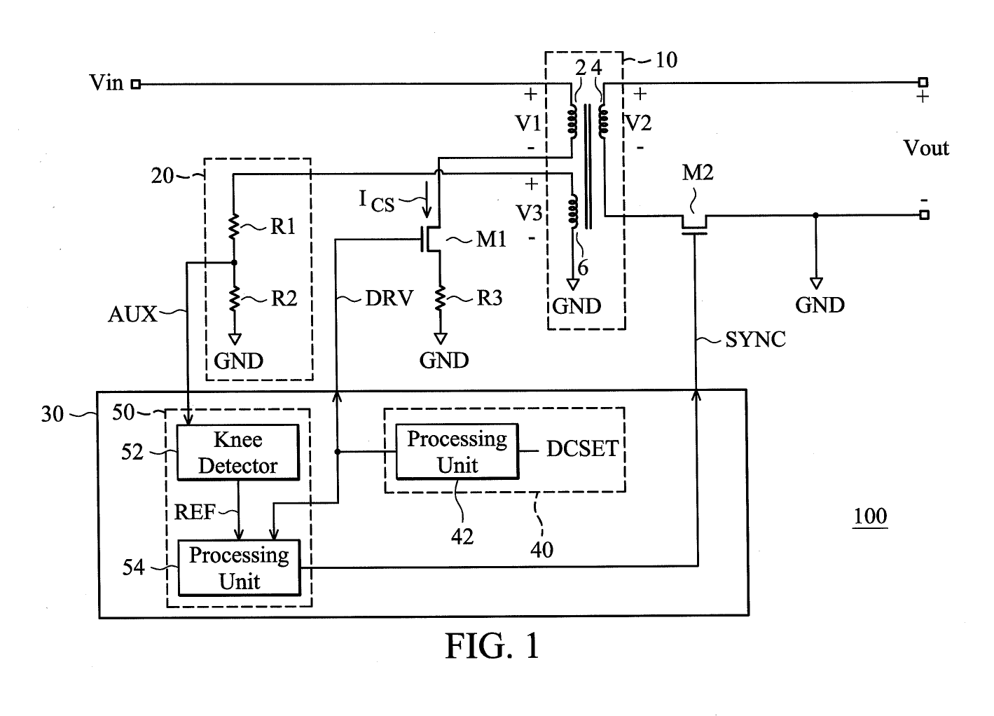

FIG. 1 shows a synchronous rectifier (SR) power converter 100 for converting an input voltage Vin into an output voltage Vout according to an embodiment of the invention. In the embodiment, the power converter 100 can operate in a continuous current mode (CCM) or a discontinuous current code (DCM). The power converter 100 comprises a transformer 10, a reference unit 20, a controller 30 and the transistors M1 and M2. The transformer 10 comprises a primary winding 2, a secondary winding 4 and an auxiliary winding 6. The primary winding 2 is disposed on a primary side of the transformer 10, which provides a primary voltage V1 according to the input voltage Vin. The secondary winding 4 is disposed on a secondary side of the transformer 10, which provides a secondary voltage V2 according to the primary voltage V1. The auxiliary winding 6 is disposed on the primary side of the transformer 10, which provides a reflection voltage V3 according to the secondary voltage V2. The reference unit 20 is coupled to the auxiliary winding 6 of the transformer 10, wherein the reference unit 20 provides a reference voltage AUX according to the reflection voltage V3. In the embodiment, the reference unit 20 is a voltage divider comprising two resistors R1 and R2, which is used to scale the reflection voltage V3, so as to generate the reference voltage AUX that is suitable for the controller 30. For example, if the controller 30 is implemented in an integrated circuit (IC), the reference unit 20 is capable of scaling the reflection voltage V3 to generate the reference voltage AUX, such that the reference voltage AUX to be input to the controller 30 can conform to specifications of the IC. The transistor M1 is an NMOS transistor coupled between the primary winding 2 and a ground GND, which has a gate for receiving a control signal DRV provided by the controller 30. A resistor R3 is coupled between the transistor M1 and the ground GND. The transistor M2 is an NMOS transistor coupled between the secondary winding 4 and the ground GND, which has a gate for receiving a control signal SYNC provided by the controller 30. In the embodiment, each of the transistors M1 and M2 functions as a switch. The controller 30 comprises a main unit 40 and a synchronous rectifier unit 50. The main unit 40 comprises a processing unit 42 for providing the control signal DRV to switch the transistor M1, so as to control the transformer 10 to generate the secondary voltage V2, wherein a duty cycle of the control signal DRV is set according to a control signal DCSET. Simultaneously, the processing unit 42 also provides the control signal DRV to the synchronous rectifier unit 50. The synchronous rectifier unit 50 comprises a knee detector 52 and a processing unit 54. The knee detector 52 detects the reference voltage AUX from the reference unit 20 to generate a reference signal REF. The processing unit 54 receives the reference signal REF and the control signal DRV to generate the control signal SYNC. The processing unit 54 provides the control signal SYNC to switch the transistor M2, so as to provide the output voltage Vout in response to the secondary voltage V2. In the embodiment, the output voltage Vout is equal to the secondary voltage V2 when the transistor M2 is turned on by the control signal SYNC.

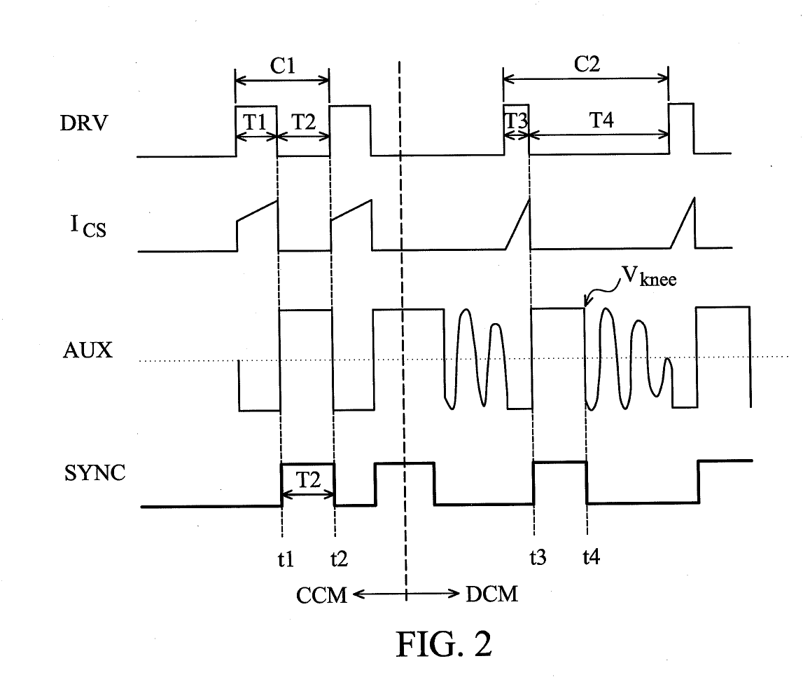

FIG. 2 shows an exemplary waveform illustrating the signals of the synchronous rectifier power converter 100 of FIG. 1. Referring to FIG. 1 and FIG. 2 together, when the power converter 100 is operating in a continuous conduction mode (CCM), the processing unit 42 continuously provides the control signal DRV with a duty cycle C1 to the transistor M1, wherein the duty cycle C1 is determined according to the control signal DCSET. If the transistor M1 is turned on by the control signal DRV during the time period T1, e.g. the control signal DRV has a logic level HIGH, a current I_{CS} from the primary winding 2 is allowed to flow through the transistor M1. Next, at time point t1, the control signal DRV is changed from a logic level HIGH to a logic level LOW by the processing unit 42, so as to turn off the transistor M1 during the time period T2, wherein T1+T2=C1. Thus, no current I_{CS} from the primary winding 2 is allowed to flow through the transistor M1 during the time period T2. Once the processing unit 54 detects that the control signal DRV is changed from a logic level HIGH to a logic level LOW, the processing unit 54 provides the control signal SYNC with a logic level HIGH to turn on the transistor M2, so as to provide the output voltage Vout to a load. Simultaneously, the reflection voltage V3 is generated in response to the secondary voltage V2, and the reference voltage AUX corresponding to the reflection voltage V3 is provided to the Knee detector 52. Next, the Knee detector 52 detects the reference voltage AUX to provide the reference signal REF, wherein the reference signal REF is used to indicate whether the reference voltage AUX is smaller than a knee voltage Vₖₙₑₑ. The knee voltage Vₖₙₑₑ is defined as a specific value of the reference voltage AUX which represents that an output current of the power converter 100 flowing through the secondary winding 4 of the transformer 10 is substantially equal to zero during each switching cycle of the transistor M2, i.e. the energy stored in the secondary winding 4 of the transformer 10 is empty. Next, at the time point t2, the control signal DRV is changed from a logic level LOW to a logic level HIGH by the processing unit 42, so as to turn on the transistor M1 again. In response to the transition of the control signal DRV, the processing unit 54 provides the control signal SYNC with a logic level LOW, to turn off the transistor M2.

Furthermore, when the power converter 100 is operating in a discontinuous conduction mode (DCM), the processing unit 42 continuously provides the control signal DRV with a duty cycle C2 to the transistor Ml, wherein the duty cycle C2 is determined according to the control signal DCSET. Similarly, if the transistor M1 is turned on by the control signal DRV during the time period T3, e.g. the control signal DRV has a logic level HIGH, the current I_{CS} from the primary winding 2 is allowed to flow through the transistor M1. Next, at the time point t3, the control signal DRV is changed from a logic level HIGH to a logic level LOW by the processing unit 42, so as to turn off the transistor M1 during the time period T4, wherein T3+T4=C2. Thus, no current I_{CS} from the primary winding 2 is allowed to flow through the transistor M1 during the time period T4. Once the processing unit 54 detects that the control signal DRV is changed from a logic level HIGH to a logic level LOW, the processing unit 54 provides the control signal SYNC with a logic level HIGH to turn on the transistor M2, so as to provide the output voltage Vout to the load. Simultaneously, the reflection voltage V3 is generated in response to the secondary voltage V2, and the reference voltage AUX corresponding to the reflection voltage V3 is provided to the Knee detector 52. Next, the Knee detector 52 detects the reference voltage AUX to provide the reference signal REF. At the time point t4, the Knee detector 52 detects that the reference voltage AUX is smaller than the knee voltage Vₖₙₑₑ (i.e. the output current of the power converter 100 flowing through the secondary winding 4 of the transformer 10 is substantially equal to zero), and then the Knee detector 52 provides the reference signal REF to notify the processing unit 54. In response to the reference signal REF, the processing unit 54 provides the control signal SYNC with a logic level LOW to turn off the transistor M2, thus a reverse current from the load of the power converter 100 to the transformer 10 can be blocked.

In FIG. 1, the control signals DRV and SYNC can both provided by the controller 30, wherein the controller 30 is an isolation device. Once the transistor M1 is turned on by the processing unit 42, the processing unit 54 immediately provides the control signal SYNC to turn off the transistor M2. Furthermore, once the transistor M1 is turned off by the processing unit 42 and the reference signal REF indicates that the reference voltage AUX has exceeded the knee voltage, the processing unit 54 immediately provides the control signal SYNC to the transistor M2, so as to turn on the transistor M2. Next, the processing unit 54 provides the control signal SYNC to turn off the transistor M2 when the transistor M1 is turned on by the processing unit 42 again or the reference voltage AUX is smaller than the knee voltage Vₖₙₑₑ. As described above, the control signal SYNC is determined according to the control signal DRV and the reference signal REF, such that the secondary side of the transformer 10 is synchronous to the primary side of the transformer 10. Thus, compatibility for DCM and CCM of the power converter 100 is improved. Furthermore, a dead time between the control signals DRV and SYNC is optimized, thereby obtaining High efficiency. Moreover, compared with a conventional power converter, no DCM sensor (e.g. MOSFET characteristics, sensing resistor or current transformer) is needed for the power converter 100.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power converter, comprising:
a transformer, comprising a primary winding for providing a primary voltage according to an input voltage, a secondary winding for providing a secondary voltage according to the primary voltage and an auxiliary winding for providing a reflection voltage according to the secondary voltage;
a first switch coupled between the primary winding of the transformer and a ground, having a control terminal for receiving a first control signal;
a second switch coupled to the secondary winding, having a control terminal for receiving a second control signal; and
a controller, providing the first control signal to switch the first switch, so as to control the transformer to provide the secondary voltage,
wherein the controller provides the second control signal to switch the second switch according to the first control signal and the reflection voltage, so as to provide an output voltage in response to the secondary voltage.

2. The power converter as claimed in claim 1, wherein the controller comprises:
a knee detector, detecting a reference voltage corresponding to the reflection voltage, to provide a reference signal; and
a processor, providing the second control signal according to the first control signal and the reference signal.

3. The power converter as claimed in claim 2, wherein the processor provides the second control signal to turn off the second switch when the first switch is turned on by the first control signal.

4. The power converter as claimed in claim 3, wherein when the first switch is turned off by the first control signal and the reference signal indicates that the reference voltage exceeds a knee voltage, the processor provides the second control signal to turn on the second switch.

5. The power converter as claimed in claim 4, wherein the knee voltage is a specific value of the reference voltage, indicates that a current flowing through the secondary winding of the transformer is substantially equal to zero.

6. The power converter as claimed in claim 4, wherein when the first switch is turned off by the first control signal and the reference signal indicates that the reference voltage is smaller than the knee voltage, the processor provides the second control signal to turn off the second switch.

7. The power converter as claimed in claim 3, wherein the processor provides the second control signal to turn on the second switch when the first switch is turned off by the first control signal and the power converter is operating in a continuous conduction mode.

8. The power converter as claimed in claim 3, wherein when the first switch is turned off by the first control signal and the power converter is operating in a discontinuous conduction mode, the processor provides the second control signal to turn on the second switch until the reference signal indicates that the reference voltage is smaller than a knee voltage.

9. The power converter as claimed in claim 8, wherein the knee voltage is a specific value of the reference voltage, indicates that a current flowing through the secondary winding of the transformer is substantially equal to zero.

10. A power converter, comprising:
a transformer, comprising a primary winding for providing a primary voltage according to an input voltage and a secondary winding for providing a secondary voltage according to the primary voltage;
a reference unit coupled to the transformer, providing a reference signal according to a reflection voltage corresponding to the secondary voltage;
a first switch coupled between the primary winding of the transformer and a ground;
a second switch coupled to the secondary winding; and
a controller, switching the first switch, so as to control the transformer to provide the secondary voltage,
wherein the controller switches the second switch according to the reference voltage and a switching state of the first switch, so as to provide an output voltage in response to the secondary voltage.

11. The power converter as claimed in claim 10, wherein when the first switch is turned on, the second switch is turned off by the controller.

12. The power converter as claimed in claim 11, wherein when the first switch is turned off and the reference voltage exceeds a knee voltage, the second switch is turned on by the controller.

13. The power converter as claimed in claim 12, wherein the knee voltage is a specific value of the reference voltage, indicates that a current flowing through the secondary winding of the transformer is substantially equal to zero.

14. The power converter as claimed in claim 12, wherein when the first switch is turned off and the reference voltage is smaller than the knee voltage, the second switch is turned off by the controller.

15. The power converter as claimed in claim 11, wherein the second switch is turned on by the controller when the first switch is turned off and the power converter is operating in a continuous conduction mode.

16. The power converter as claimed in claim 11, wherein when the first switch is turned off and the power converter is operating in a discontinuous conduction mode, the second switch is turned on until the reference voltage is smaller than a knee voltage.

17. The power converter as claimed in claim 16, wherein the knee voltage is a specific value of the reference voltage, indicates that a current flowing through the secondary winding of the transformer is substantially equal to zero.

18. A control method for a power converter, wherein the power converter comprises a transformer, a first switch and a second switch, comprising:
providing a first control signal to switch the first switch coupled between a primary winding of the transformer and a ground, so as to control the transformer to provide a secondary voltage at a secondary winding of the transformer, wherein an auxiliary winding of the transformer provides a reflection voltage according to the secondary voltage; and
providing a second control signal to switch the second switch coupled to the secondary winding according to the first control signal and the reflection voltage,
wherein the power converter provides an output voltage in response to the secondary voltage.

19. The control method as claimed in claim 18, wherein the step of providing the second control signal to switch the second switch coupled to the secondary winding according to the first control signal and the reflection voltage further comprising:
detecting a reference voltage corresponding to the reflection voltage, to provide a reference signal; and
providing the second control signal according to the first control signal and the reference signal.

20. The control method as claimed in claim 19, wherein the second switch is turned of by the second control signal when the first switch is turned on by the first control signal.

21. The control method as claimed in claim 20, wherein when the first switch is turned off by the first control signal and the reference signal indicates that the reference voltage exceeds a knee voltage, the second switch is turned on by the second control signal.

22. The control method as claimed in claim 21, wherein the knee voltage is a specific value of the reference voltage, indicates that a current flowing through the secondary winding of the transformer is substantially equal to zero.

23. The control method as claimed in claim 21, wherein when the first switch is turned off by the first control signal and the reference signal indicates that the reference voltage is smaller than the knee voltage, the second switch is turned off by the second control signal.

24. The control method as claimed in claim 20, wherein the second switch is turned on by the second control signal when the first switch is turned off by the first control signal and the power converter is operating in a continuous conduction mode.

22. The control method as claimed in claim 20, wherein when the first switch is turned off by the first control signal and the power converter is operating in a discontinuous conduction mode, the second switch is turned on by the second control signal until the reference signal indicates that the reference voltage is smaller than a knee voltage.

23. The control method as claimed in claim 22, wherein the knee voltage is a specific value of the reference voltage, indicates that a current flowing through the secondary winding of the transformer is substantially equal to zero.
